(19) United States
(12) Patent Application Publication
(10) Pub. No.: US 2025/0125561 A1
(43) Pub. Date: Apr. 17, 2025

(54) QUICK CONDUCTOR CONNECTOR

(71) Applicants: SWITCHLAB INC., NEW TAIPEI CITY (TW); SWITCHLAB (SHANGHAI) CO., LTD., SHANGHAI CITY (CN); GAOCHENG ELECTRONICS CO., LTD., GUANGDONG PROVINCE (CN)

(72) Inventors: CHIH-YUAN WU, NEW TAIPEI CITY (TW); CHIH-HAO SUNG, NEW TAIPEI CITY (TW); YI-WEN QIU, NEW TAIPEI CITY (TW)

(21) Appl. No.: 18/903,503

(22) Filed: Oct. 1, 2024

(30) Foreign Application Priority Data
Oct. 11, 2023 (TW) 112210910

(51) Int. Cl. H01R 13/629; H01R 13/639

(52) U.S. Cl. CPC H01R 13/62927; H01R 13/639

(57) ABSTRACT

A quick conductor connector includes a receiving space recessed from a top of a main body, the receiving space having an annular stepped section formed around a top opening thereof with locating guide sections spaced thereon and sockets formed on a bottom thereof for receiving conductors therein; a locating member disposed on the annular stepped section and provided on inner and outer circumferential edges with stop sections and extensions, respectively; the extensions being extendable into the locating guide sections for guiding the locating member to rotate and change the positions of the stop sections relative to the annular stepped section; and a plug member including electrically conducting sections extendable into the sockets and electrically connected to the conductors, and limiting sections that can be blocked by the stop sections when the locating member is rotated to thereby prevent the plug member from sliding upward out of the receiving space.

### FIELD OF THE INVENTION

The present invention relates to an improved quick conductor connector, and more particularly to a connector that has simple structure and can be conveniently operated to securely connect to electrical conductors without the risk of loosening easily.

### BACKGROUND OF THE INVENTION

The conventional control component, such as a switch component or terminal block, is usually provided on an outer surface with conducting plates that are electrically connectable to contacts inside the control component and to a conductor outside the control component, so that the control component can be used to operate and control an external mechanism via the conductor. In the early days, the conducting plates on the control component can be connected to the external conductor in different ways, one of which that is very commonly seen is to provide screw threads on the conducting plates for bolts or nuts to screw thereto, and the bolts or the nuts are tightly pressed against an end of the external conductor to form a physical and electrical connection of the control component with the external conductor.

The above way of connecting the control component to the external conductor is relatively troublesome and the locating effect provided by tightly pressing the bolts to the conductor is not good and could not continue for long. The bolts (i.e. the conducting plates) are easily loosened or separated from the conductor because the switch component or the terminal block is subjected to vibration or unexpected pull by an external force now and then. Further, the bolts or other similar parts or structures provided on the conducting plates also increase an overall volume of the switch component or the terminal block, which is disadvantageous to the trends of developing miniature and compact products.

There is another way in which the conducting plates are directly welded to the external conductor. The welding ensures better connection strength between the conducting plates and the external conductor and avoids disadvantageous loosening or separating of the connection due to vibration and external force over a long time. In addition, the bolts or nuts are omitted to reduce the production cost and the overall volume of the product.

When the switch component or the terminal block being fixedly welded to the conductor is damaged or failed, desoldering is required to remove the conducting plates from the conductor. The desoldering is an inconvenient and complicate process to increase the difficulty in subsequent repair and maintenance of the control component and forms a shortage in the application of the control component.

Thus, another way is developed, in which a conductor connector is used as a structure to connect the control component to the external conductor. The conductor connector usually includes a plurality of sockets for contacting with conducting pins on the control component to form electrical connection between the conductor connector and the control component, and a plurality of conducting sections outward extended and exposed from the sockets. The conducting sections can be directly welded to the conductors while nuts and screw threads can also be provided to help in holding the conductors in place. Since the conductor connector enables simple and quick electrical connection of the control component to the conductors, it has been widely applied in the occasions that use switch components or terminal blocks.

In the above described conductor connector, the sockets are usually insertion holes, which internally include connection terminals for connecting to the external conductors. When the control component is partially plugged into the conductor connector, the exposed conducting plates of the control component are inserted into the insertion holes to contact with the connection terminals to form an electrical connection between the control component and the conductor. However, this connection structure simply relies on the insertion of the conducting plates into the insertion holes and could not provide sufficient connection strength, and the connection structure is very easily loosened or separated when being pulled by an undesired external force. Therefore, it is necessary for related manufacturers to develop and provide a connection mechanism that can be easily operated to securely connect the conductor connector to the control component, i.e. the switch component or the terminal block.

In view of the problems in the conventional connection structure for connecting the switch component or terminal block to the external conductor, it is therefore tried by the inventor to develop an improved quick conductor connector.

### SUMMARY OF THE INVENTION

A primary object of the present invention is to provide a quick conductor connector, which includes a main body, an annular locating member, and a plug member. The main body has a receiving space recessed from a top thereof, and the receiving space is formed around a top opening with an annular stepped section having a plurality of locating guide sections spaced thereon and is provided on a bottom with a plurality of sockets. The locating member is disposed on the annular stepped section and is provided on inner and outer circumferential edges with stop sections and extensions, respectively. The extensions are extendable into the locating guide sections to guide the locating member to rotate and change the positions of the stop sections relative to the annular stepped section. The plug member includes limiting sections and electrically conducting sections extending into the receiving space. The electrically conducting sections are extended into the sockets and electrically connected to conductors received in the sockets. When the locating member is rotated to move the stop sections to a top of the limiting sections, the limiting section are blocked by the stop sections and the plug member is prevented from sliding out of or loosening from the receiving space. The quick conductor connector having the above structure is easy to operate and enables stable and secured electrical connection of a switch component to the conductors.

Another object of the present invention is to provide the above quick conductor connector, each of the locating guide sections 15 of which includes a horizontal guide slot extending along the top opening of the receiving space, and a guide opening located at an end of the horizontal guide slot and extended vertically to communicate with an outer side of the receiving space. The extensions on the locating member can pass the guide openings to extend into and slide in the horizontal guide slot, so as to guide the locating member to rotate in the annular stepped section.

A further object of the present invention is to provide the above quick conductor connector, each of the limiting sections of which includes a sideward protruded portion and an inverted-U shaped clamping portion; and the receiving space of the main body is provided on an inner wall surface with a radially inner clamping slot corresponding to the sideward protruded portion and a locating protrusion corresponding to the inverted-U shaped clamping portion. The radially inner clamping slot can be fitted around the sideward protruded portion, and the inverted-U shaped clamping portion can be clamped to the locating protrusion, so that the plug member is stably and securely connected to the main body without rotating relative to the main body.

A still further object of the present invention is to provide the above quick conductor connector, of which the annular stepped section of the main body is provided with a cut, and the locating member is provided on an outer circumferential edge with a push section. The push section can pass the cut to be located at an outer side of the main body for a user to easily rotate the locating member relative to the annular stepped section.

A still further object of the present invention is to provide the above quick conductor connector, of which the annular stepped section of the main body is provided with a radially inward protrusion, and the locating member is provided on the outer circumferential edge with a first and a second locating dent. The first and second locating dents are movable along with the rotating locating member to align and engage with the radially inward protrusion, so that the locating member can be held to one of a locked position and an unlocked position.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a quick conductor connector according to a preferred embodiment of the present invention;

FIG. 2 is a partially assembled perspective view of the quick conductor connector of FIG. 1;

FIG. 3 is a fully assembled perspective view of the quick conductor connector of FIG. 1;

FIG. 4 is a front elevation of FIG. 3;

FIG. 5 is a sectional view taken along line A-A of FIG. 4;

FIG. 6 is a sectional view taken along line B-B of FIG. 4; and

FIG. 7 is a sectional top view of FIG. 6 showing the quick conductor connector is in a locked state.

### DETAILED DESCRIPTION OF THE PREFERRED EMBODIMENTS

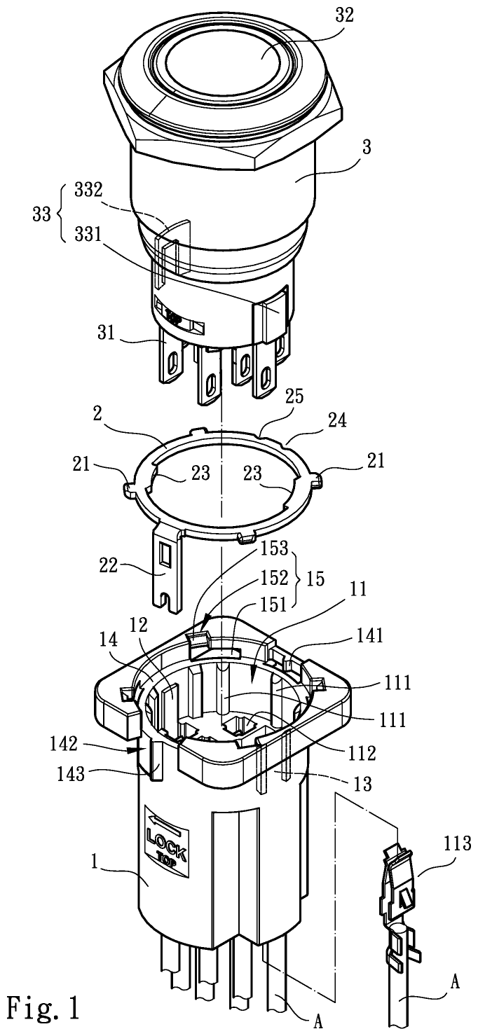

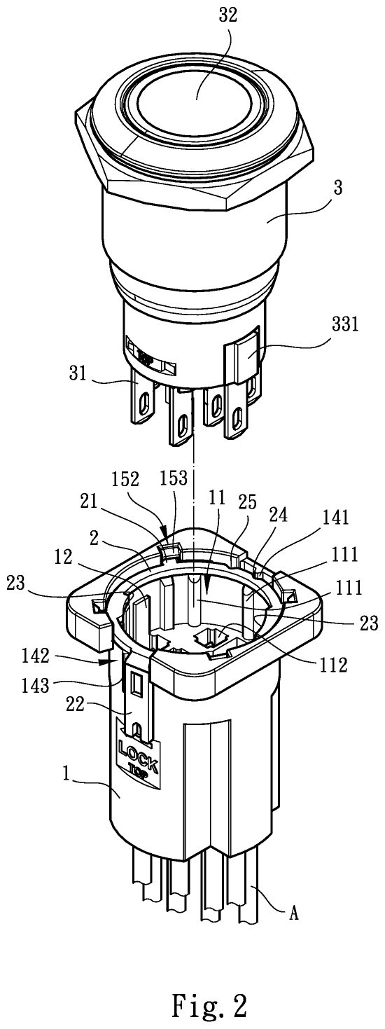

Please refer to FIGS. 1 and 2. A quick conductor connector according to a preferred embodiment of the present invention includes a main body 1, a locating member 2, and a plug member 3. The main body 1 has a receiving space 11 recessed from a top surface thereof; a locating protrusion 12, and a radially inner side clamping slot 13. A plurality of ribs 111 is provided between the locating protrusion 12 and the radially inner clamping slot 13, and a plurality of sockets 112 is provided on a bottom of the receiving space 11. The sockets 112 respectively have a conductor “A” received therein.

In a feasible embodiment, the sockets 112 can be insertion holes respectively having a connection terminal 113 received therein for connecting to the conductor A correspondingly received in the sockets 112.

The receiving space 11 is provided on a top opening with a radially outward expanded annular stepped section 14. A plurality of locating guide sections 15 and a cut 142 are formed on a circumferential wall surface of the annular stepped section 14. The cut 142 has a radially outward protrusion 143 located at a middle portion thereof. Further, a radially inward protrusion 141 may be provided on the annular stepped section 14 according to actual need.

In a feasible embodiment, each of the locating guide sections 15 includes a horizontal guide slot 151 extending along the top opening of the receiving space 11 by a predetermined length, and a guide opening 152 located at an end of the horizontal guide slot 151 and extended vertically to communicate with an outer side of the main body 1. A stopper 153 is protruded radially from the guide opening 152; and one side of the stopper 153 facing toward an outer side of the guide opening 152 may be formed with a beveled guide surface (not shown), if necessary.

The locating member 2 is an annular structure corresponding to the annular stepped section 14 and has a plurality of radially outward projected extensions 21 and a push section 22 spaced along an outer circumferential edge thereof. The extensions 21 are located corresponding to the guide openings 152 while the push section 22 is located corresponding to the cut 142. The locating member 2 further has a plurality of radially inward projected stop sections 23 spaced along an inner circumferential edge thereof and located corresponding to the locating protrusion 12 and the radially inner clamping slot 13. In addition, the locating member 2 may have a first locating dent 24 and a second locating dent 25 formed on its outer circumferential edge. When the locating member 2 is rotated relative to the annular stepped section 14, one of the first and the second locating dent 24, 25 can be located corresponding to the radially inward protrusion 141.

To assemble the locating member 2 to the main body 1, first position the extensions 21 in the guide openings 152. With the beveled guide surfaces provided on the stoppers 153, the extensions 21 can pass the stoppers 153 more easily to extend into the horizontal guide slots 151. Meanwhile, since the stoppers 153 block the guide openings 152, the extensions 21 are effectively prevented from sliding out of the guide openings 152 and the locating member 2 is slidably assembled to the annular stepped section 14 on the main body 1. At this point, the push section 22 can pass the cut 142 to be located at an outer side of the main body 1. When the push section 22 is located at an unlocked position, i.e. located at a lateral side of the radially outward protrusion 143, the radially inward protrusion 141 is engaged with the first locating dent 24, so that the locating member 2 is fixedly held in place on the main body 1 with the radially inward projected stop sections 23 being located in a staggered relation to the locating protrusions 12 and the radially inner clamping slot 13 on the main body 1 (i.e. in an unlocked state). On the other hand, when the locating member 2 is operated via the push section 22 to rotate on the annular stepped section 14, the push section 22 can be moved to another lateral side of the radially outward protrusion 143 into a locked position. At this point, the radially inward protrusion 141 is engaged with the second locating dent 25 and the locating member 2 is held in place on the main body 1. Meanwhile, the stop sections 23 on the locating member 2 are displaced to positions corresponding to the locating protrusion 12 and the radially inner clamping slot 13 (i.e. in a locked state).

The plug member 3 is a structure connectable to the main body 1. The plug member 3 is provided on an outer surface with at least one limiting section 33 and a plurality of electrically conducting sections 31. In a feasible embodiment, the limiting sections 33 include a sideward protruded portion 331 located corresponding to the radially inner clamping slot 13 and an inverted-U shaped clamping portion 332 located corresponding to the locating protrusion 12.

In the illustrated preferred embodiment, the plug member 3 is a switch component. In this case, the plug member 3 further includes an operating section 32 located at an outer side of the plug member 3 for controlling the electrically conducting sections 31 to an electrical connected or disconnected state.

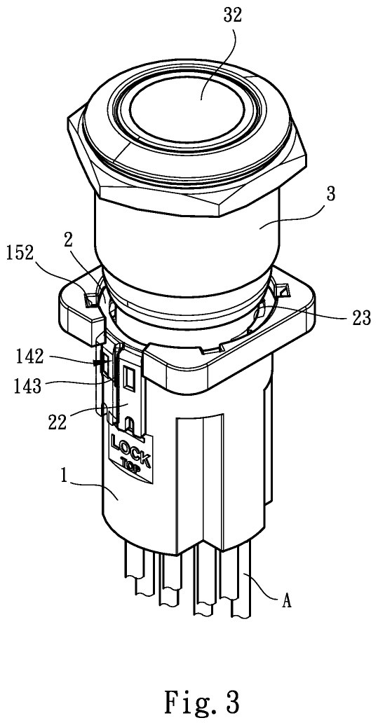

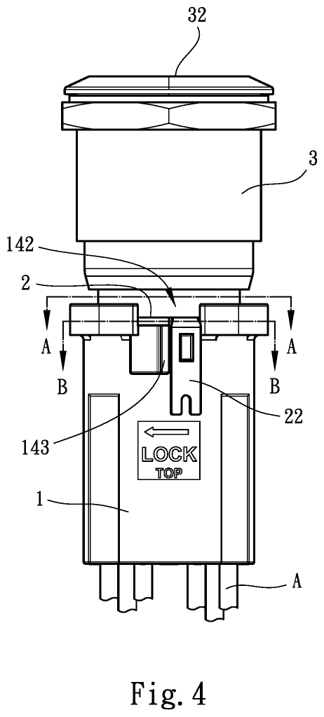

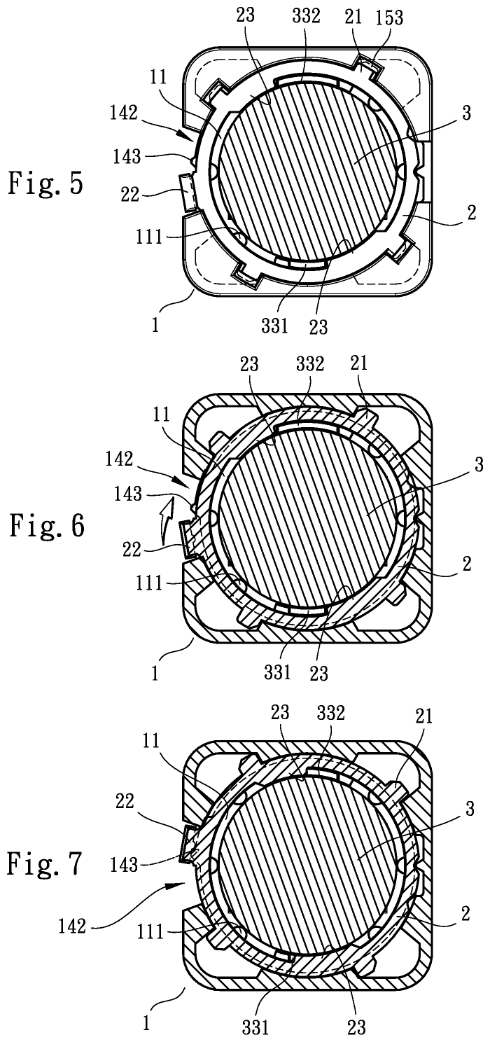

Please refer to FIGS. 3 to 7 for the use of the quick conductor connector of the present invention. When the locating member 2 is located at the unlocked position, the stop sections 23 are located in a staggered relation to the locating protrusion 12 and the radially inner clamping slot 13, so that the inverted-U shaped clamping portion 332 and the sideward protruded portion 331 on the plug member 3 can be smoothly extended through the locating member 2 into the receiving space 11. Then, the inverted-U shaped clamping portion 332 is clamped on the locating protrusion 12 and the sideward protruded portion 331 is protruded into the radially inner clamping slot 13, so that the plug member 3 is non-rotatably engaged with the main body 1, as shown in FIGS. 3 and 5. Meanwhile, the ribs 111 are pressed against the outer side of the plug member 3 to contact with the plug member 3 with a relatively low friction between them, allowing the plug member 3 to be smoothly plugged into the receiving space 11.

After the plug member 3 is inserted to a predetermined position in the receiving space 11, the electrically conducting sections 31 of the plug member 3 can be correspondingly extended into the sockets 112 to contact with the connection terminals 113, enabling the electrically conducting sections 31 to be electrically connected to the conductors A. Then, the push section 22 is operated to rotate the locating member 2 for the extensions 21 to slide in corresponding horizontal guide slots 151, as shown in FIG. 6, so that the push section 22 initially located at one lateral side of the radially outward protrusion 143 in the unlocked position is moved to another lateral side of the radially outward protrusion 143 and changes to the locked position. Meanwhile, the radially inward protrusion 141 is engaged with the second locating dent 25 and held in place. At this point, the radially inward projected stop sections 23 are also moved to locations above the sideward protruded portion 331 and the inverted-U shaped clamping portion 332, respectively, as shown in FIG. 7. Therefore, the plug member 3 is firmly held in the receiving space 11 without the possibility of sliding out of the receiving space 11 and accordingly, the quick conductor connector of the present invention forms a locating mechanism that can be easily operated to realize secured electrical connection of the plug member 3 to the conductors A.

According to the above discussion, the quick conductor connector of the present invention has the advantages of having simple structure and being easily operable to form stable and secured electrical connection to electrical conductors. Therefore, the present invention meets the requirements of novelty and improvement for granting a patent. It is also understood the present invention has been described with a preferred embodiment thereof and it is understood that many changes and modifications in the described embodiment can be carried out without departing from the scope and the spirit of the invention that is intended to be limited only by the appended claims.

What is claimed is:

1. A quick conductor connector, comprising:
a main body (1) having a receiving space (11) recessed from a top thereof, a radially outward expanded annular stepped section (14) formed around a top opening of the receiving space (11), a plurality of locating guide sections (15) spaced along a circumferential wall surface of the annular stepped section (14), a plurality of sockets (112) formed on a bottom of the receiving space (11), and a conductor (A) received in each of the sockets (12);
an annular locating member (2) being disposed on the annular stepped section (14) and having a plurality of radially outward protruded extensions (21) formed on an outer circumferential edge thereof for correspondingly extending into and slidably moving in the locating guide sections (15), and the annular locating member (2) further having a plurality of radially inward projected stop sections (23) formed on an inner circumferential edge thereof; and
a plug member (3) having at least one limiting section and a plurality of electrically conducting sections (31) provided on an outer surface thereof; the electrically conducting sections (31) being electrically connected to the conductors (A) in the sockets (112); the limiting sections (33) on the plug member (3) being able to pass the locating member (2) and extend into the receiving space (11) of the main body (1) when the radially inward projected stop sections (23) on the locating member (2) are located in a staggered relation to the limiting sections (33), and then the locating member (2) being rotatable to move the stop sections (23) to positions blocking the limiting sections (33) from upward passing the locating member (2), so that the plug member (3) is prevented from sliding out of the receiving space (11).

2. The quick conductor connector as claimed in claim 1, wherein each of the limiting sections (33) includes a sideward protruded portion (331) located on the outer surface of the plug member (3), and the receiving space (11) of the main body (1) being provided on an inner wall surface thereof with a radially inner clamping slot (13) corresponding to each sideward protruded portion (331); and the plug member (3) being stably and securely held in the receiving space (11) when the radially inner clamping slot (13) is correspondingly clamped on the sideward protruded portion (331) while one corresponding stop section (23) on the locating member (2) is located above the sideward protruded portion (331) to block the limiting section (33) from sliding upward.

3. The quick conductor connector as claimed in claim 1, wherein the receiving space (11) of the main body (1) is provided on an inner wall surface thereof with a locating protrusion (12), the limiting section (33) of the plug member (3) further including an inverted-U shaped clamping portion (332) corresponding to the locating protrusion (12); and the plug member (3) being stably and securely held in the receiving space (11) when the inverted-U shaped clamping portion (332) is fitted around the locating protrusion (12) while one corresponding stop section (23) on the locating member (2) is located above the inverted-U shaped clamping portion (332) to block the same from sliding upward.

4. The quick conductor connector as claimed in claim 1, wherein the locating guide sections (15) respectively include a horizontal guide slot (151) extended along the top opening of the annular stepped section (14) of the receiving space (11), a guide opening (152) located at an end of the horizontal guide slot (151) and extending vertically to communicate with an outer side of the receiving space (11), and a stopper (153) protruded radially inward from the guide opening (152).

5. The quick conductor connector as claimed in claim 2, wherein the locating guide sections (15) respectively include a horizontal guide slot (151) extended along the top opening of the annular stepped section (14) of the receiving space (11), a guide opening (152) located at an end of the horizontal guide slot (151) and extending vertically to communicate with an outer side of the receiving space (11), and a stopper (153) protruded radially inward from the guide opening (152).

6. The quick conductor connector as claimed in claim 3, wherein the locating guide sections (15) respectively include a horizontal guide slot (151) extended along the top opening of the annular stepped section (14) of the receiving space (11), a guide opening (152) located at an end of the horizontal guide slot (151) and extending vertically to communicate with an outer side of the receiving space (11), and a stopper (153) protruded radially inward from the guide opening (152).

7. The quick conductor connector as claimed in claim 1, wherein the annular stepped section (14) on the main body (1) is provided with a cut (142), and the locating member (2) including a push section (22) located on the outer circumferential edge thereof at a position corresponding to the cut (142), such that the push section (22) can pass the cut (142) to be located at an outer side of the main body (1).

8. The quick conductor connector as claimed in claim 2, wherein the annular stepped section (14) on the main body (1) is provided with a cut (142), and the locating member (2) including a push section (22) located on the outer circumferential edge thereof at a position corresponding to the cut (142), such that the push section (22) can pass the cut (142) to be located at an outer side of the main body (1).

9. The quick conductor connector as claimed in claim 3, wherein the annular stepped section (14) on the main body (1) is provided with a cut (142), and the locating member (2) including a push section (22) located on the outer circumferential edge thereof at a position corresponding to the cut (142), such that the push section (22) can pass the cut (142) to be located at an outer side of the main body (1).

10. The quick conductor connector as claimed in claim 4, wherein the annular stepped section (14) on the main body (1) is provided with a cut (142), and the locating member (2) including a push section (22) located on the outer circumferential edge thereof at a position corresponding to the cut (142), such that the push section (22) can pass the cut (142) to be located at an outer side of the main body (1).

11. The quick conductor connector as claimed in claim 1, wherein the annular stepped section (14) of the main body (1) is provided with a radially inward protrusion (141) and the locating member (2) is provided on an outer circumferential edge with a first locating dent (24) and a second locating dent (25); the first locating dent (24) and the second locating dent (25) being displaced when the locating member (2) is rotated relative to the annular stepped section (14), such that one of the first and the second locating dent (24, 25) is aligned and engaged with the radially inward protrusion (141) to hold the locating member (2) to one of a locked position and an unlocked position.

12. The quick conductor connector as claimed in claim 2, wherein the annular stepped section (14) of the main body (1) is provided with a radially inward protrusion (141) and the locating member (2) is provided on an outer circumferential edge with a first locating dent (24) and a second locating dent (25); the first locating dent (24) and the second locating dent (25) being displaced when the locating member (2) is rotated relative to the annular stepped section (14), such that one of the first and the second locating dent (24, 25) is aligned and engaged with the radially inward protrusion (141) to hold the locating member (2) to one of a locked position and an unlocked position.

13. The quick conductor connector as claimed in claim 3, wherein the annular stepped section (14) of the main body (1) is provided with a radially inward protrusion (141) and the locating member (2) is provided on an outer circumferential edge with a first locating dent (24) and a second locating dent (25); the first locating dent (24) and the second locating dent (25) being displaced when the locating member (2) is rotated relative to the annular stepped section (14), such that one of the first and the second locating dent (24, 25) is aligned and engaged with the radially inward protrusion (141) to hold the locating member (2) to one of a locked position and an unlocked position.

14. The quick conductor connector as claimed in claim 4, wherein the annular stepped section (14) of the main body (1) is provided with a radially inward protrusion (141) and the locating member (2) is provided on an outer circumferential edge with a first locating dent (24) and a second locating dent (25); the first locating dent (24) and the second locating dent (25) being displaced when the locating member (2) is rotated relative to the annular stepped section (14), such that one of the first and the second locating dent (24, 25) is aligned and engaged with the radially inward protrusion (141) to hold the locating member (2) to one of a locked position and an unlocked position.

15. The quick conductor connector as claimed in claim 7, wherein the annular stepped section (14) of the main body (1) is provided with a radially inward protrusion (141) and the locating member (2) is provided on an outer circumferential edge with a first locating dent (24) and a second locating dent (25); the first locating dent (24) and the second locating dent (25) being displaced when the locating member (2) is rotated relative to the annular stepped section (14), such that one of the first and the second locating dent (24, 25) is aligned and engaged with the radially inward protrusion (141) to hold the locating member (2) to one of a locked position and an unlocked position.

16. The quick conductor connector as claimed in claim 1, wherein the receiving space (11) includes a plurality of ribs (111) formed on an inner wall surface thereof for pressing against the outer surface of the plug member (3).

17. The quick conductor connector as claimed in claim 2, wherein the receiving space (11) includes a plurality of ribs (111) formed on an inner wall surface thereof for pressing against the outer surface of the plug member (3).

18. The quick conductor connector as claimed in claim 3, wherein the receiving space (11) includes a plurality of ribs (111) formed on an inner wall surface thereof for pressing against the outer surface of the plug member (3).

19. The quick conductor connector as claimed in claim 1, wherein the plug member (3) is a switch component, and the plug member (3) including an operating section (32) operable to control ON and OFF of the switch component.

20. The quick conductor connector as claimed in claim 1, wherein the sockets (112) are insertion holes respectively allowing one of the electrically conducting sections (31) to extend thereinto, and each of the sockets (112) further having a connection terminal (113) received therein for electrically connecting to a corresponding one of the conductors (A).
